(19) United States
(12) Patent Application Publication
(10) Pub. No.: US 2016/0073314 A1
(43) Pub. Date: Mar. 10, 2016

(54) REDIRECTION HISTORY BASED CIRCUIT SWITCHED FALL BACK

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/480,256

(22) Filed: Sep. 8, 2014

(51) Int. Cl. H04W 36/24; H04W 36/00

(52) U.S. Cl. CPC H04W 36/245; H04W 36/0022

(57) ABSTRACT

A user equipment (UE) receives a connection release message from a serving base station of a first radio access technology (RAT), without redirection information. The connection release message is received during a circuit switched fall back procedure from the first RAT to a second RAT. The UE redirects to the second RAT based on redirection history.

### BACKGROUND

1. Field

Aspects of the present disclosure relate generally to wireless communication systems, and more particularly, to circuit switched fall back redirection when a connection release message is received from a serving base station of a first radio access technology (RAT), without redirection information.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes receiving a connection release message from a serving base station of a first radio access technology (RAT), without redirection information, during a circuit switched fall back procedure from the first RAT to a second RAT. The method also includes redirecting to the second RAT based on redirection history.

According to another aspect of the present disclosure, an apparatus for wireless communication includes means for receiving a connection release message from a serving base station of a first radio access technology (RAT), without redirection information, during a circuit switched fall back procedure from the first RAT to a second RAT. The apparatus may also include means for redirecting to the second RAT based on redirection history.

Another aspect discloses an apparatus for wireless communication and includes a memory and at least one processor coupled to the memory. The processor(s) is configured to receive a connection release message from a serving base station of a first radio access technology (RAT), without redirection information, during a circuit switched fall back procedure from the first RAT to a second RAT. The processor(s) is also configured to redirect to the second RAT based at least in part on redirection history.

Another aspect discloses a computer program product for wireless communications in a wireless network having a non-transitory computer-readable medium. The computer readable medium has non-transitory program code recorded thereon which, when executed by the processor(s), causes the processor(s) to perform the operation of receiving a connection release message from a serving base station of a first radio access technology (RAT), without redirection information, during a circuit switched fall back procedure from the first RAT to a second RAT. The program code also causes the processor(s) to redirect to the second RAT based on redirection history.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a method for wireless communication according to one aspect of the present disclosure.

FIG. 6 is a call flow diagram illustrating a network operation according to one aspect of the present disclosure.

FIG. 7 is a flow diagram illustrating a method for wireless communication according to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

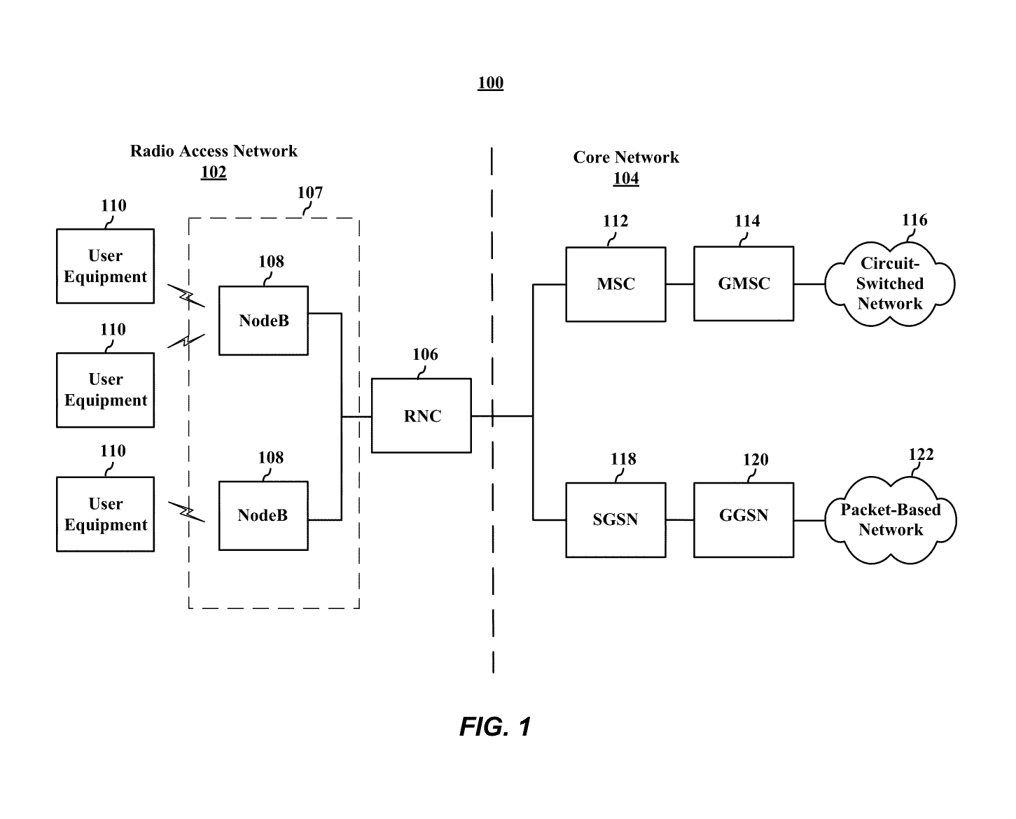

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than those available with standard GSM circuit switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

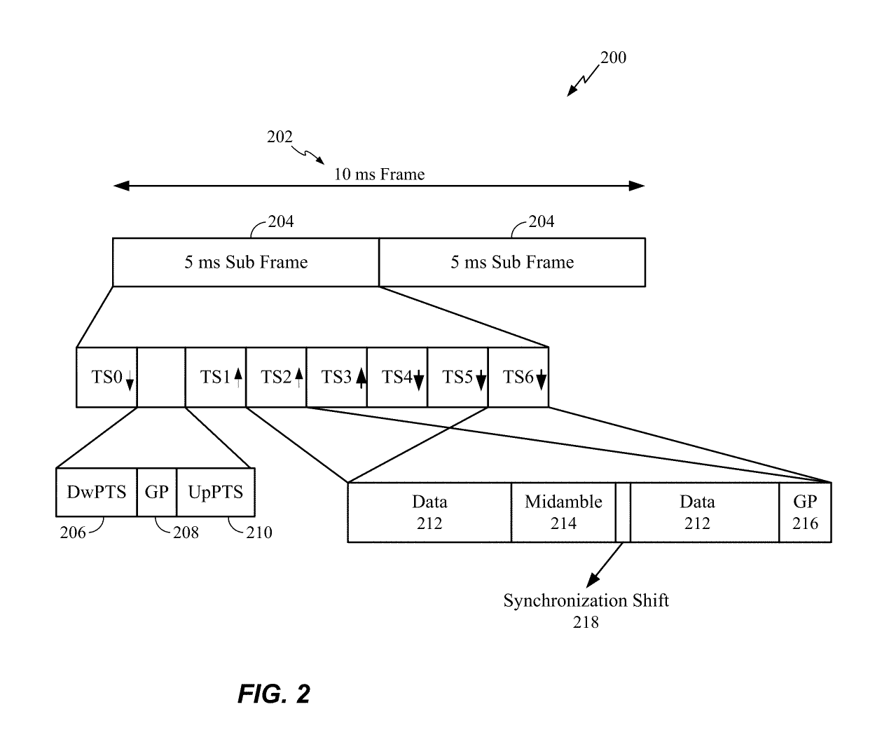

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization Shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

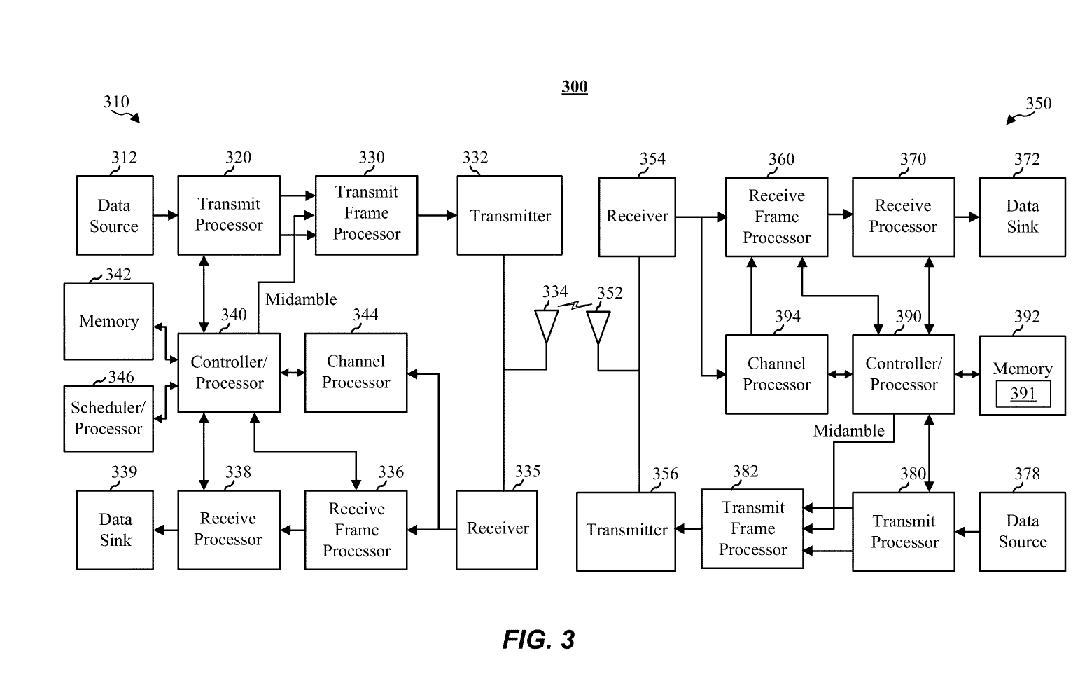

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a redirection module 391 which, when executed by the controller/processor 390, configures the UE 350 for cell redirection. A scheduler/processor 346 at the node B 310 may be used to allocate resources to the UEs and schedule downlink and/or uplink transmissions for the UEs.

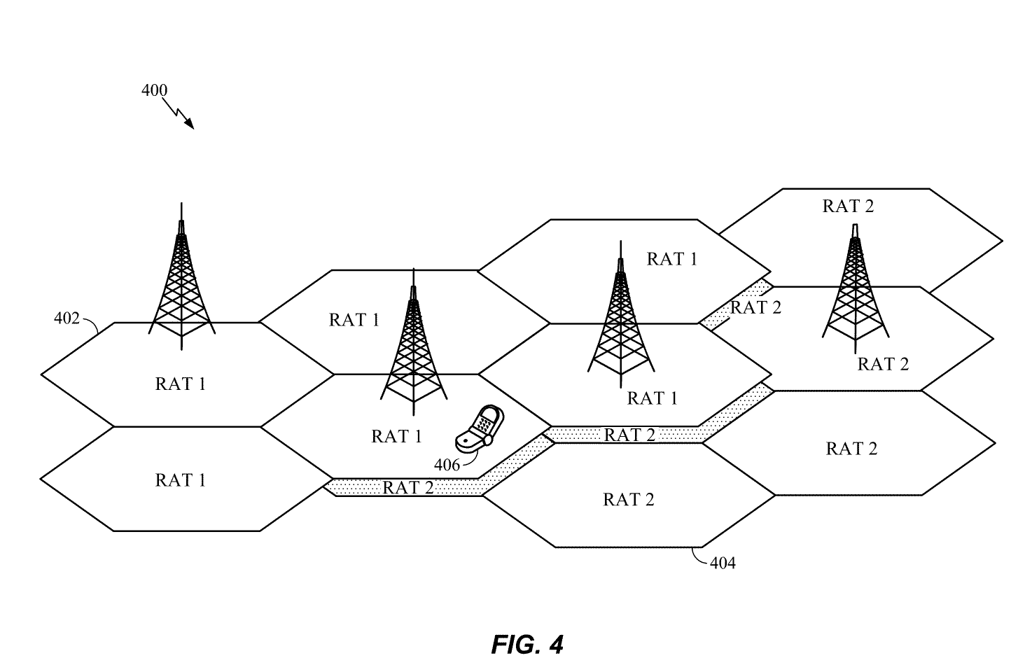

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as a GSM, TD-SCDMA or Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

Redirection from one RAT to another RAT is commonly used to perform operations such as load balancing or circuit switched fallback from one RAT to another RAT. For example, one of the RATs may be long term evolution (LTE) while the other RAT may be universal mobile telecommunications system—frequency division duplexing (UMTS FDD), universal mobile telecommunications system—time division duplexing (UMTS TDD), or global system for mobile communications (GSM). In some aspects, the redirection may be from a frequency or cell of one RAT to a frequency or cell of the same RAT.

Circuit switched fall back is a feature that enables multimode user equipments (UEs) that are capable of communicating on a first RAT (e.g., LTE) in addition to communicating on a second RAT (e.g., second/third generation (2G/3G) RAT) to obtain circuit switched voice services while being camped on the first RAT. For example, the circuit switched fall back capable UE may initiate a mobile-originated (MO) circuit switched voice call while on LTE. Because of the mobile-originated circuit switched voice call, the UE is redirected to a circuit switched capable RAT. For example, the UE is redirected to a radio access network (RAN), such as a 3G/2G network, for the circuit switched voice call setup. In some instances, the circuit switched fall back capable UE may be paged for a mobile-terminated (MT) voice call while on LTE, which results in the UE being moved to second/third generation RAT for the circuit switched voice call setup.

A user equipment (UE) may receive a circuit switched (CS) page from a first base station of a first radio access technology (RAT) or initiate a circuit switched call to the first base station. For example, a circuit switched fall back capable UE may be paged for a mobile-terminated (MT) voice call while on the first RAT (e.g., long term evolution (LTE)) or may initiate a mobile-originated (MO) circuit switched voice call while the user equipment is in LTE connected or idle mode. In response to the page, the UE is redirected to a second RAT (e.g., third generation (3G)/second generation (2G)) to set up the circuit-switched voice call. For example, to set up the circuit switched voice call on the second RAT, the UE may receive a connection release message from a base station of the first RAT. The connection release message may include redirection information that indicates the RAT (e.g., target base station of a second RAT), frequency and/or cell to which the user equipment is to be redirected for the circuit switched fall back call. The redirection information may also include system information. For example, the redirection information may include base station identifiers with associated system information. In some instances, however, the connection release message may not include the redirection information.

Without the redirection information, the circuit switched fall back call may fail. One way to mitigate the failure is by re-sending the page for the mobile-terminated voice call (e.g., after 5-10 seconds) or re-initiating the circuit switched call. However, re-sending or re-initiating the circuit switched call due to the call establishment failure is time consuming and further adversely affects user perception. Thus, it is desirable to mitigate circuit switched fall back establishment failure.

### Redirection History Based Circuit Switched Fall Back

Aspects of the present disclosure are directed to avoiding circuit switched fall back establishment failure and to improving throughput of a circuit switched fall back call setup. In one aspect of the disclosure, when the connection release message does not include redirection information, the UE redirects to the second RAT based on a redirection history that exists for the first RAT. The redirection history may be used instead of giving up or aborting the call due to call setup failure. To create the redirection history, redirection information corresponding to previous successful or unsuccessful redirection attempts from the first base station may be stored in the user equipment. For example, previous redirection information corresponding to previous successful attempts from the first base station of the first RAT to a second base station of the second RAT may be included in the redirection history. The redirection history associated with the previous successful attempt to the second base station may be used to redirect the UE to the second base station when the connection release message (e.g., radio resource control (RRC) connection release message) does not include redirection information.

The redirection information stored in the user equipment may include, for example, previous redirection information such as cell identification of base stations (e.g., second RAT base station), location area identifiers of the second RAT, frequency of the second RAT (e.g., third generation/second generation RAT), and identification (e.g., public land mobile network (PLMN) identification) of cell(s) of the second RAT. The redirection information may also include an indication of whether a redirection was successful, and other redirection related information. The redirection information may further include acquired system information, base station identifiers, etc., associated with cells of the second RAT for which redirection attempts were successful. For example, the redirection history includes system information block(s) (SIB(s)) corresponding to one or more cell identifiers of the second RAT. In one aspect, the UE uses the redirection information for future circuit switched fall back connection attempts, thus speeding up redirection attempts when the connection release message does not include redirection information.

The received connection release message may be in response to an intermediary event and not a response associated with the circuit switched fall back procedure. For example, when a UE is in connected mode, with the first base station of the first RAT (e.g., LTE), and receives a circuit switched page or initiates a circuit switched call, the UE sends an extended service request to a mobility management entity of the wireless network. However, prior to receiving a response to the extended service request or prior to sending the extended service request, a data call inactivity timer expires. The data call inactivity timer may be initiated in conjunction with a packet switched (PS) communication via the first RAT.

The expiration of the data call inactivity timer triggers a connection release message to release the UE from the packet switched (PS) communication. Thus, the triggered connection release message is received, instead of a connection release message in response to the extended service request. As a result, the received connection release message does not include the redirection information.

In some instances, the base station of the second RAT may fail to send a connection release message or may send a connection release message without redirection information when the base station of the second RAT does not support circuit switched fall back communication, when the UE is not configured for circuit switched fall back communication and/or when the mobility management entity does not support circuit switched fall back communication. As noted, without the redirection information, the circuit switched fall back call may fail and cause a drop in user perception.

In one aspect of the present disclosure, the circuit switched fall back call is established based on the redirection history. For example, if the UE previously made a circuit switched fall back call to a particular base station, a list of frequencies or cell identifiers with/without system information associated with the base station can be identified. The UE can create redirection information based on the circuit switched fall back history and tune to the circuit switched RAT to perform the circuit switched fall back call setup procedure.

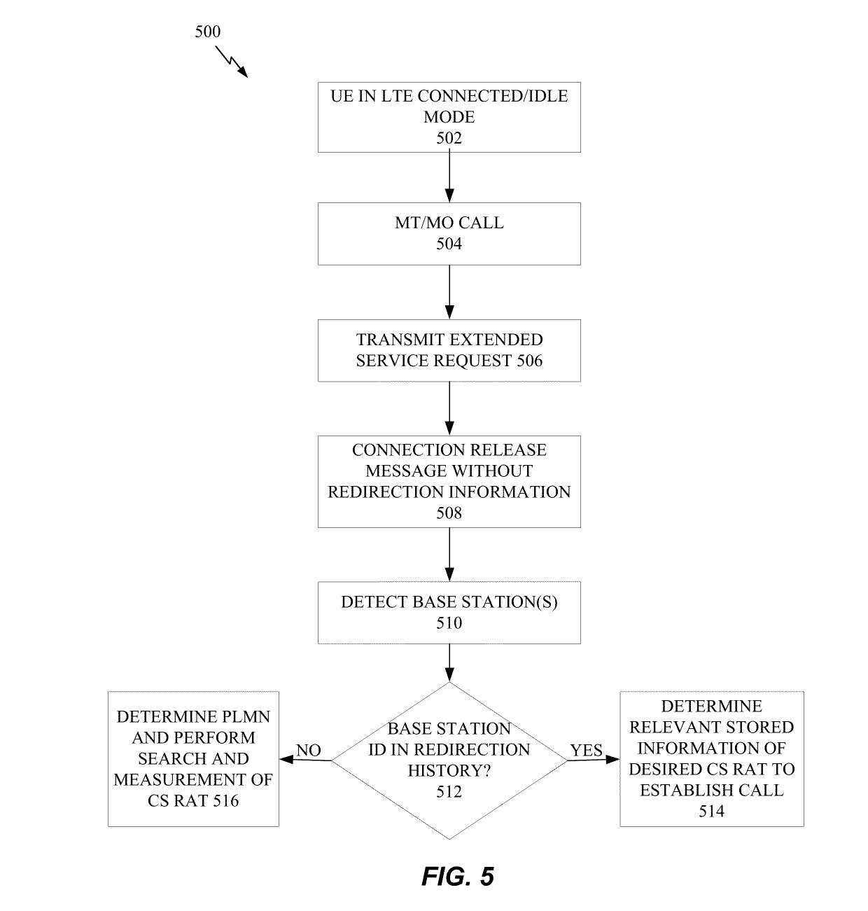

FIG. 5 shows a wireless communication method 500 according to one aspect of the disclosure. A user equipment is in connected mode or idle mode with a packet switched RAT (e.g., LTE), as shown in block 502. While in the idle or connected mode, the user equipment may be paged for a mobile-terminated voice call or may initiate a mobile-originated voice call, as shown in block 504. To set up the voice call (i.e., circuit switched voice call), the user equipment communicates with a mobility management entity (MME) via the packet switched RAT (e.g., the eNodeB). For example, the user equipment transmits an extended service request to the MME, as shown in block 506. The extended service request is in response to the mobile-originated or mobile-terminated circuit switched fallback call.

In one aspect of the present disclosure, the packet switched RAT transmits and the user equipment receives a connection release message without redirection information, as shown in block 508. The user equipment then performs a scan to detect packet switched base station (e.g., LTE eNodeB) identifier(s), as shown in block 510.

The user equipment then determines whether any of the detected packet switched base station identifiers are included in the redirection history, as shown in block 512. When the user equipment determines that the packet switched base station identifier is included in the redirection history, the user equipment determines relevant information (stored in memory) of the desired circuit switched RAT to establish the circuit switched call, as in block 514. For example, the user equipment determines or identifies a list of previous successful circuit switched RATs and corresponding circuit switched frequencies/cells, and other relevant redirection information for establishing the circuit switched call. When the user equipment determines that the packet switched base station identifier is not included in the redirection history, the user equipment identifies the public land mobile network and performs a random access search and measurement of a circuit switch RAT associated with the public land mobile network, as in block 516.

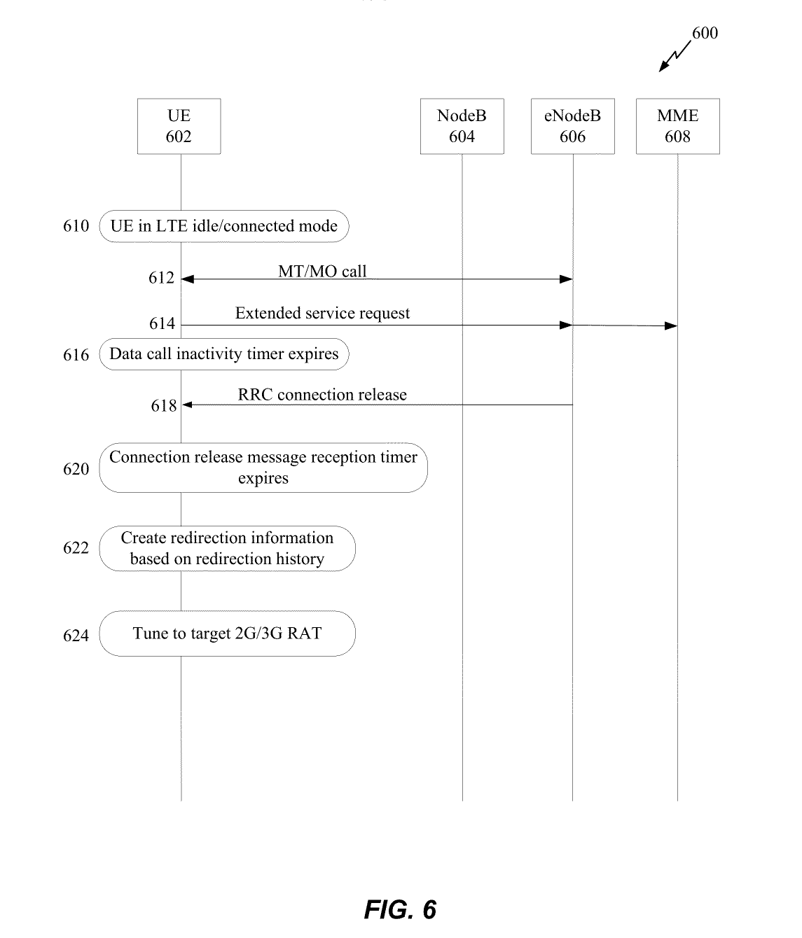

FIG. 6 is a call flow diagram 600 illustrating a network operation according to some aspects of the present disclosure. A UE 602 may be in a coverage area of a second/third generation (e.g., TD-SCDMA) NodeB 604, a fourth generation (e.g., LTE) eNodeB 606 and a mobility management entity (MME) 608, which is a control node for the network. At time 610, the UE 602 is in the idle or connected mode with the eNodeB 606. While in the idle or connected mode, the UE 602 may be paged for a mobile-terminated (MT) voice call or may initiate a mobile-originated (MO) voice call, at time 612. At time 614, the UE 602 transmits an extended service request to the MME 608. In one aspect, the MME 608 may not receive the extended service request or an intervening activity may cause the eNodeB 606 to fail to transmit a connection release message in response to the extended service request (i.e., with redirection information).

For example, prior to receiving a response to the extended service request or prior to sending the extended service request, a data call inactivity timer expires, at time 616. The data call inactivity timer may be initiated in conjunction with packet switched (PS) communications with the eNodeB 606. The expiration of the data call inactivity timer triggers a connection release message from the eNodeB 606 to release the UE 602 from the packet switched (PS) communication, at time 618. As noted, the triggered connection release message is received, instead of a connection release message in response to the extended service request. As a result, the received connection release message does not include the redirection information.

In one aspect of the disclosure, after the UE 602 sends the extended service request, the UE starts a connection release reception timer. The connection release reception timer indicates a time period that the UE 602 waits to receive the connection release message in response to the extended service request. The connection release reception timer expires, at time 620, before receiving the connection release message in response to the extended service request. In one aspect of the disclosure, the UE creates the redirection information based on the redirection history, at time 622, and tunes to the circuit switched RAT to proceed with the establishment of the circuit switched fall back call, at time 624, in accordance with the redirection history.

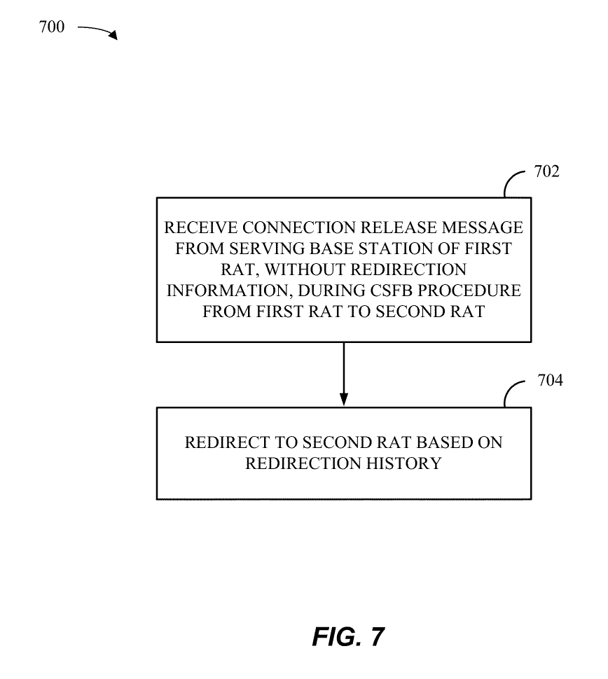

FIG. 7 shows a wireless communication method 700 according to one aspect of the disclosure. A UE receives a connection release message from a serving base station of a first radio access technology (RAT) during a circuit switched fall back procedure from the first RAT to a second RAT, as shown in block 702. The connection release message does not include redirection information. The UE then redirects to the second RAT based on redirection history, as shown in block 704.

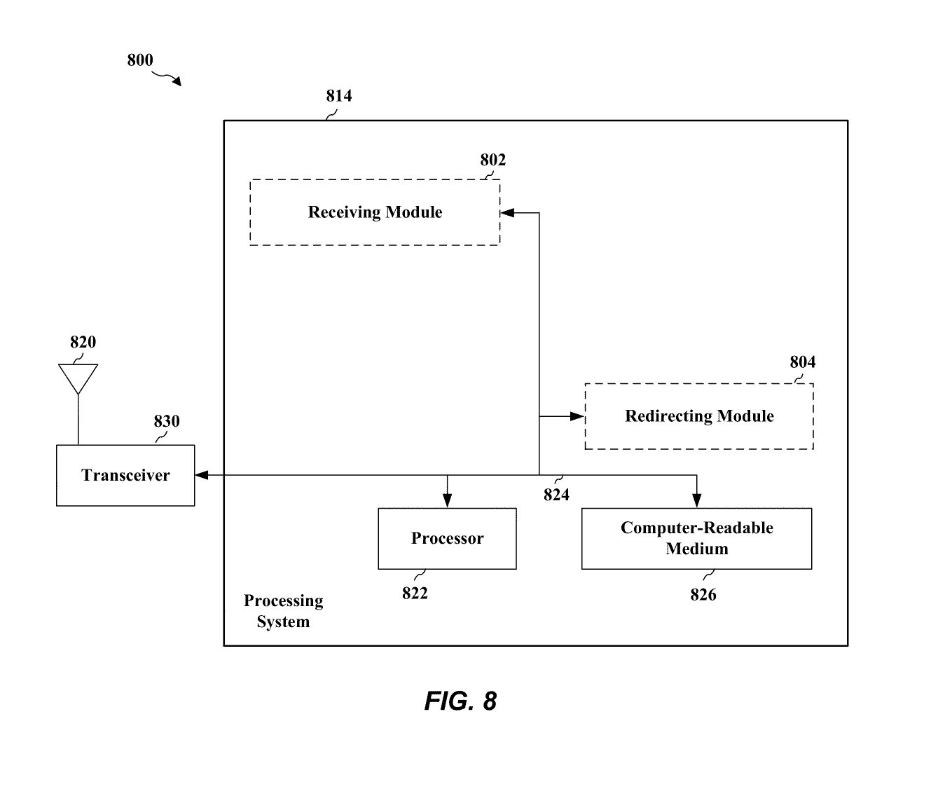

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804 and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a receiving module 802 for receiving a connection release message from a serving base station of a first radio access technology (RAT). The processing system 814 includes a redirecting module 804 for redirecting to the second RAT based on redirection history. The modules may be software modules running in the processor 822, resident/stored in the computer-readable-medium 826, one or more hardware modules coupled to the processor 822, or some combination thereof. The processing system 814 may be a component of the UE 350 and may include the memory 392, and/or the controller/processor 390.

In one configuration, an apparatus such as a UE is configured for wireless communication including means for receiving. In one aspect, the receiving means may be the antennas 352/820, the receiver 354, the transceiver 830, the channel processor 394, the receive frame processor 360, the receive processor 370, the controller/processor 390, the memory 392, the redirection module 391, the receiving module 802, and/or the processing system 814 configured to perform the aforementioned means.

The UE is also configured to include means for redirecting. In one aspect, the redirecting means may be the antennas 352/820, the receiver 354, the channel processor 394, the receive frame processor 360, the receive processor 370, the transmitter 356, the transmit frame processor 382, the transmit processor 380, the controller/processor 390, the memory 392, redirection module 391, the redirecting module 804 and/or the redirection processing system 814 configured to perform the aforementioned means. In one configuration, the means functions correspond to the aforementioned structures. In another aspect, the aforementioned means may be any module or any apparatus configured to perform the functions recited by the aforementioned means.

Several aspects of a telecommunications system have been presented with reference to LTE, TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a connection release message from a serving base station of a first radio access technology (RAT), without redirection information, during a circuit switched fall back procedure from the first RAT to a second RAT; and
redirecting to the second RAT based at least in part on redirection history.

2. The method of claim 1, in which the redirection history comprises at least one frequency of the second RAT.

3. The method of claim 1, in which the redirection history comprises at least one cell identification of the second RAT.

4. The method of claim 3, in which the redirection history comprises a system information block (SIB) corresponding to the at least one cell identification of the second RAT.

5. The method of claim 1, in which the connection release message is in response to a data call inactivity timer expiring.

6. The method of claim 1, further comprising:
sending an extended service request; and
receiving the connection release message prior to the extended service request being received at the second RAT or prior to sending the extended service request.

7. An apparatus for wireless communication, comprising:
means for receiving a connection release message from a serving base station of a first radio access technology (RAT), without redirection information, during a circuit switched fall back procedure from the first RAT to a second RAT; and
means for redirecting to the second RAT based at least in part on redirection history.

8. The apparatus of claim 7, in which the redirection history comprises at least one frequency of the second RAT.

9. The apparatus of claim 7, in which the redirection history comprises at least one cell identification of the second RAT.

10. The apparatus of claim 9, in which the redirection history comprises a system information block (SIB) corresponding to the at least one cell identification of the second RAT.

11. The apparatus of claim 7, in which the connection release message is in response to a data call inactivity timer expiring.

12. The apparatus of claim 7, further comprising:
means for sending an extended service request; and
means for receiving the connection release message prior to the extended service request being received at the second RAT or prior to sending the extended service request.

13. An apparatus for wireless communication, comprising:
a memory; and
at least one processor coupled to the memory and configured:
to receive a connection release message from a serving base station of a first radio access technology (RAT), without redirection information, during a circuit switched fall back procedure from the first RAT to a second RAT; and
to redirect to the second RAT based at least in part on redirection history.

14. The apparatus of claim 13, in which the redirection history comprises at least one frequency of the second RAT.

15. The apparatus of claim 13, in which the redirection history comprises at least one cell identification of the second RAT.

16. The apparatus of claim 15, in which the redirection history comprises a system information block (SIB) corresponding to the at least one cell identification of the second RAT.

17. The apparatus of claim 13, in which the connection release message is in response to a data call inactivity timer expiring.

18. The apparatus of claim 13, in which the at least one processor is further configured:
to send an extended service request; and
to receive the connection release message prior to the extended service request being received at the second RAT or prior to sending the extended service request.

19. A computer program product for wireless communication, comprising:
a non-transitory computer-readable medium having program code recorded thereon, the program code comprising:
program code to receive a connection release message from a serving base station of a first radio access technology (RAT), without redirection information, during a circuit switched fall back procedure from the first RAT to a second RAT; and
program code to redirect to the second RAT based at least in part on redirection history.

20. The computer program product of claim 19, in which the redirection history comprises at least one frequency of the second RAT.

21. The computer program product of claim 19, in which the redirection history comprises at least one cell identification of the second RAT.

22. The computer program product of claim 21, in which the redirection history comprises a system information block (SIB) corresponding to the at least one cell identification of the second RAT.

23. The computer program product of claim 19, in which the connection release message is in response to a data call inactivity timer expiring.

24. The computer program product of claim 19, further comprising program code:
to send an extended service request; and
to receive the connection release message prior to the extended service request being received at the second RAT or prior to sending the extended service request.
